(19) United States
(12) Patent Application Publication
(10) Pub. No.: US 2020/0149454 A1
(43) Pub. Date: May 14, 2020

(54) SYSTEM FOR SEPARATING LIQUID EXHAUST REDUCTANT FROM A MIXING CONDUIT WALL USING A FLOW SEPARATION NOZZLE

(71) Applicant: CNH Industrial America LLC, New Holland, PA (US)

(72) Inventors: Kaushal Ghorpade, Chicago, IL (US); Panos Tamamidis, Northbrook, IL (US); Samrendra K. Singh, Bolingbrook, IL (US); Hesam Abbassi, Birmingham, MI (US)

(73) Assignee: CNH Industrial America LLC

(21) Appl. No.: 16/190,803

(22) Filed: Nov. 14, 2018

(51) Int. Cl. F01N 3/28; B01D 53/94; F01N 3/20; B01F 5/04; B01F 5/06; B01F 3/04

(52) U.S. Cl. CPC F01N 3/2892; B01D 53/9431; F01N 3/2066; F01N 2610/02; B01F 5/0651; B01F 3/04049; F01N 2610/1453; B01F 5/0473

(57) ABSTRACT

An exhaust treatment system for a work vehicle includes a reductant injector configured to inject an exhaust reductant into the engine exhaust flow flowing through a mixing conduit. A flow separation nozzle is located downstream of the reductant injector and is configured to separate a liquid reductant flow from an inner conduit wall of the mixing conduit for mixing with the engine exhaust flow flowing therein.

### FIELD OF THE INVENTION

The present subject matter relates generally to the treatment of engine exhaust gases, and more particularly, to systems for separating liquid exhaust reductant from an inner wall of a mixing conduit.

### BACKGROUND OF THE INVENTION

Typically, work vehicles, such as tractors and other agricultural vehicles, include an exhaust treatment system for controlling engine emissions. As is generally understood, exhaust treatment systems for work vehicles often include a diesel oxidation catalyst (DOC) system in fluid communication with a selective catalytic reduction (SCR) system. The DOC system is generally configured to oxidize carbon monoxide and unburnt hydrocarbons contained within the engine exhaust and may include a mixing chamber for mixing an exhaust reductant, such as a diesel exhaust fluid (DEF) or any other suitable urea-based fluid, into the engine exhaust. For instance, the exhaust reductant is often pumped from a reductant tank mounted on and/or within the vehicle and injected onto the mixing chamber to mix the reductant with the engine exhaust. The resulting mixture may then be supplied to the SCR system to allow the reductant to be reacted with a catalyst in order to reduce the amount of nitrous oxide (NOx) emissions contained within the engine exhaust.

One of the challenges inherent with known exhaust treatment systems lies in obtaining an efficient mixture of exhaust reductant with the diesel exhaust stream. Under known approaches, the liquid exhaust reductant is sprayed into the exhaust stream for mixing therewith. However, after a short distance, a portion of the liquid exhaust reductant typically centrifuges and impinges onto the walls of the mixing pipe. The impinged liquid will then gather into a liquid stream flowing along the wall of the pipe. Once the liquid stream is formed, a significant portion of the exhaust reductant is not available for mixture with the exhaust stream prior to entry into the SCR catalyst. This leads to inefficiencies in the exhaust treatment system as it is desirable for the exhaust reductant to be uniformly mixed with the exhaust gas to achieve the desired ratio of pollutants to reactants. A system with poorly distributed exhaust reductant is substantially inefficient, requiring excessive exhaust reductant consumption in order to meet emissions targets.

Accordingly, a system for separating liquid exhaust reductant from a mixing pipe wall so as to make the exhaust reductant available for mixing with the engine exhaust stream flowing through the mixing pipe would be welcomed in the technology.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, an exhaust treatment system for a work vehicle is provided. The system includes an exhaust conduit configured to receive an engine exhaust flow and a reductant injector configured to inject an exhaust reductant into the engine exhaust flow. The system also includes a mixing conduit extending lengthwise between an upstream end and a downstream end. The mixing conduit includes an inner conduit wall defining a flow area through which the engine exhaust flow and the exhaust reductant are directed between the upstream and downstream ends of the mixing conduit to allow the exhaust reductant to be at least partially mixed into the engine exhaust flow. A portion of the exhaust reductant flows along the inner conduit wall of the mixing conduit as a liquid reductant flow. A flow separation nozzle is provided within the mixing conduit at a location between its upstream and downstream ends. The flow separation nozzle includes a nozzle wall extending between an upstream wall end and a downstream wall end. The nozzle wall defines a radially inwardly converging profile between its upstream and downstream wall ends. The flow separation nozzle is positioned within the mixing conduit such that the liquid reductant flow flowing along the inner conduit wall is directed across the nozzle wall and separates from the flow separation nozzle for mixing with the engine exhaust flow flowing through the flow separation nozzle.

In accordance with another embodiment of the present disclosure, a work vehicle is provided. The work vehicle including an engine expelling an engine exhaust flow, an exhaust conduit configured to receive the engine exhaust flow the engine, a reductant injector configured to inject an exhaust reductant into the engine exhaust flow, and a mixing conduit extending lengthwise between an upstream end and a downstream end. The mixing conduit includes an inner conduit wall defining a flow area through which the engine exhaust flow and the exhaust reductant are directed between the upstream and downstream ends of the mixing conduit to allow the exhaust reductant to be at least partially mixed into the engine exhaust flow. A portion of the exhaust reductant flows along the inner conduit wall of the mixing conduit as a liquid reductant flow. The work vehicle also includes a flow separation nozzle provided within the mixing conduit at a location between its upstream and downstream ends. The flow separation nozzle includes a nozzle wall extending between an upstream wall end and a downstream wall end. The nozzle wall defines a radially inwardly converging profile between its upstream and downstream wall ends. The flow separation nozzle is positioned within the mixing conduit such that the liquid reductant flow flowing along the inner conduit wall is directed across the nozzle wall and separates from the flow separation nozzle for mixing with the engine exhaust flow flowing through the flow separation nozzle.

In accordance with one embodiment of the present disclosure, an exhaust treatment system for a work vehicle is provided. The system includes an exhaust conduit configured to receive an engine exhaust flow and a reductant injector configured to inject an exhaust reductant into the engine exhaust flow. The system also includes a mixing conduit extending lengthwise between an upstream end and a downstream end. The mixing conduit includes an inner conduit wall defining a flow area through which the engine exhaust flow and the exhaust reductant are directed between the upstream and downstream ends of the mixing conduit to allow the exhaust reductant to be at least partially mixed into the engine exhaust flow. A portion of the exhaust reductant flows along the inner conduit wall of the mixing conduit as a liquid reductant flow. A plurality of flow separation elements are provided within the mixing conduit at a location between its upstream and downstream ends. The flow separation elements are configured to separate the liquid reductant flow from the inner conduit wall as the liquid reductant flow is directed across the flow separation elements.

In accordance with another embodiment of the present disclosure, a work vehicle is provided. The work vehicle including an engine expelling an engine exhaust flow, an exhaust conduit configured to receive the engine exhaust flow the engine, a reductant injector configured to inject an exhaust reductant into the engine exhaust flow, and a mixing conduit extending lengthwise between an upstream end and a downstream end. The mixing conduit includes an inner conduit wall defining a flow area through which the engine exhaust flow and the exhaust reductant are directed between the upstream and downstream ends of the mixing conduit to allow the exhaust reductant to at least partially be mixed into the engine exhaust flow. A portion of the exhaust reductant flows along the inner conduit wall of the mixing conduit as a liquid reductant flow. The work vehicle also includes a plurality of flow separation elements within the mixing conduit at a location between its upstream and downstream ends. The flow separation elements are configured to separate the liquid reductant flow from the inner conduit wall as the liquid reductant flow is directed across the flow separation elements.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter;

FIG. 2 illustrates a schematic view of one embodiment of an exhaust treatment system suitable for use with a work vehicle, particularly illustrating a flow separation region associated with a mixing pipe or conduit of the system in accordance with aspects of the present subject matter;

FIG. 3 illustrates a cross-sectional view of a portion of the exhaust treatment system shown in FIG. 2 taken about line 3,6-3,6, particularly illustrating an embodiment of the exhaust treatment system in which the flow separation region includes or is configured as a flow separation nozzle;

FIG. 4 illustrates a cross-sectional view of another embodiment of the flow separation nozzle shown in FIG. 3 in accordance with aspects of the present subject matter;

FIG. 5 illustrates a cross-sectional view of a further embodiment of the flow separation nozzle shown in FIG. 3 in accordance with aspects of the present subject matter;

FIG. 6 illustrates another cross-sectional view of a portion of the exhaust treatment system shown in FIG. 2 taken about line 3,6-3,6, particularly illustrating an embodiment of the exhaust treatment system in which the flow separation region includes or is configured as a plurality of flow separation elements in accordance with aspects of the present subject matter;

FIG. 7 illustrates a cross-sectional view of the portion of the exhaust treatment system shown in FIG. 6 taken about line 7-7 in accordance with aspects of the present subject matter;

FIGS, 8A-8G illustrate differing views of various embodiments of suitably shaped elements that can be used as flow separation elements in accordance with aspects of the present subject matter.

FIG. 9 illustrates another similar cross-sectional view of the portion of the exhaust treatment system shown in FIGS. 6 and 7, particularly illustrating an embodiment including separate rows of circumferentially offset, axially aligned flow separation elements in accordance with aspects of the present subject matter;

FIG. 10 illustrates a similar cross-sectional view of the portion of the exhaust treatment system shown in FIGS. 6 and 7, particularly illustrating an embodiment including separate rows of circumferentially aligned, axially offset flow separation elements in accordance with aspects of the present subject matter;

FIG. 11 illustrates a similar cross-sectional view of the portion of the exhaust treatment system shown in FIG. 6, particularly illustrating another embodiment of a suitable configuration for the flow separation elements in accordance with aspects of the present subject matter; and

FIG. 12 illustrates a cross-sectional view of the portion of the exhaust treatment system shown in FIG. 11 taken about line 12-12 in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system for treating the engine exhaust of a work vehicle. Specifically, in several embodiments, the present subject matter is directed to systems for separating a stream of liquid exhaust reductant from the sidewall or inner conduit walls of a mixing pipe or conduit of an exhaust treatment system. Exhaust reductant is an important, consumable solution employed in treating diesel exhaust to limit air pollution, specifically nitrous oxides. To reduce the level of nitrous oxides in the diesel exhaust stream during engine operations, an exhaust reductant (e.g., a urea-water solution) is sprayed from a storage tank into the exhaust stream at a point upstream of a selective catalytic reduction (SCR) system. Optimally, all of the exhaust reductant mixes with the exhaust stream and, in the presence of the catalytic components, reacts with the nitrous oxides to produce harmless nitrogen and water. If more exhaust reductant is introduced than is required to react with the amount of nitrous oxide present, then the excess exhaust reductant is not only wasted, requiring more frequent replenishment of the storage tank, but the excess also tends to crystalize and accumulate (“caking”), thereby further reducing system efficiency. On the other hand, if an insufficient amount of exhaust reductant is available to react with the amount of nitrous oxide in the exhaust stream, the pollutant may not be reduced below air-pollution limits.

As indicated above, upon spraying or introducing the exhaust reductant into the flow of engine exhaust, a portion of the exhaust reductant often accumulates into a liquid stream along an interior wall of the mixing conduit and flows in a generally helical path along the length of the conduit to the downstream selective catalytic reduction (SCR) system. As a result, this liquid stream is unavailable for mixing with the stream of exhaust gases flowing through the mixing conduit and is also not susceptible to evaporation based on heat transfer from the interior wall of the conduit. It is thus desirable to separate this flow of liquid exhaust reductant from the interior wall of the mixing conduit and reintroduce the reductant back into the exhaust stream.

In several embodiments of the present disclosure, to allow for separation of the stream of exhaust reductant from the interior wall of the mixing conduit, a flow separation nozzle may be incorporated into and/or otherwise provided in operative association with the mixing conduit downstream of the injection point for the exhaust reductant. in general, the flow separation nozzle may define a generally radially inwardly converging profile or configuration such that an upstream diameter of the nozzle is greater than its downstream diameter. Thus, as the liquid stream of exhaust reductant encounters the leading edge of the flow separation nozzle, the liquid reductant stream is separated from the inner wall of the mixing conduit and travels across the length of the nozzle face along its radially inwardly converging profile toward the centerline of the mixing conduit. As the liquid reductant stream reaches a downstream end or edge of the nozzle, the liquid stream separates from the nozzle face and is reintroduced into the stream of exhaust gases flowing through the nozzle. Specifically, at the downstream end of the nozzle, the liquid reductant stream may be picked up and carried by the flow of engine exhaust being accelerated through the converging nozzle, thereby facilitating enhanced mixing of the reductant within the exhaust.

Moreover, in addition to the flow separation nozzle (or as an alternative thereto), a plurality of individual flow separation elements may be incorporated within or otherwise provided in operative association with the mixing conduit of the exhaust treatment system downstream of the injection point of the exhaust reductant to allow the liquid reductant stream to be separated from the interior wall of the mixing conduit. In several embodiments, the flow separation elements may be configured as a plurality of turbulators, such as a plurality of protrusions, ribs, or other elements extending radially inwardly from the inner wall of the mixing conduit or a plurality of indentations or recesses formed in the inner wall of the mixing conduit. In such embodiments, when the liquid reductant stream encounters the flow separation elements, the portion of the liquid stream contacting or otherwise interacting with the flow separation element may be deflected from the inner wall of the mixing conduit and into the stream of exhaust gases for mixing therewith.

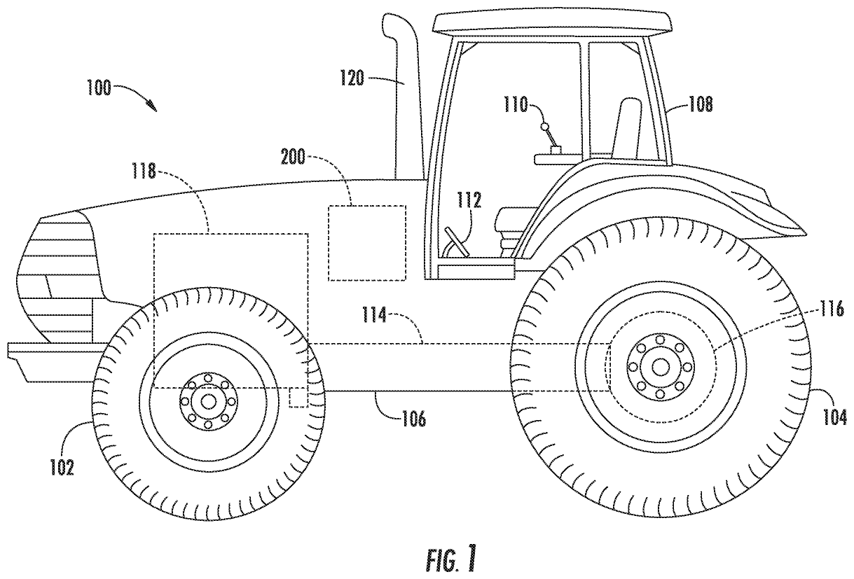

Referring now to the drawings, FIG. 1 illustrates a side view of one embodiment of a work vehicle 100. As shown, the work vehicle 100 is configured as an agricultural tractor. However, in other embodiments, the work vehicle 100 may be configured as any other suitable work vehicle known in the art, such as various other agricultural vehicles, earth-moving vehicles, road vehicles, all-terrain vehicles, off-road vehicles, loaders and/or the like.

As shown in FIG. 1, the work vehicle 100 includes a pair of front wheels 102, a pair or rear wheels 104, and a chassis 106 coupled to and supported by the wheels 102, 104. An operator's cab 108 may be supported by a portion of the chassis 106 and may house various control devices 110, 112 (e.g., levers, pedals, control panels and/or the like) for permitting an operator to control the operation of the work vehicle 100. Additionally, the work vehicle 100 may include an engine 118 and a transmission 114 mounted on the chassis 106. The transmission 114 may be operably coupled to the engine 118 and may provide variably adjusted gear ratios for transferring engine power to the wheels 104 via a differential 116.

Moreover, the work vehicle 100 may also include an exhaust treatment system 200 for reducing the amount emissions contained within the exhaust from the engine 118. For instance, engine exhaust expelled from the engine 118 may be directed through the exhaust treatment system 200 to allow the levels of nitrous oxide (NOx) emissions contained within the exhaust to be reduced significantly. The cleaned exhaust gases may then be expelled from the exhaust treatment system 200 into the surrounding environment via an exhaust pipe 120 of the work vehicle 100.

It should be appreciated that the configuration of the work vehicle 100 described above and shown in FIG. 1 is provided only to place the present subject matter in an exemplary field of use. Thus, it should be appreciated that the present subject matter may be readily adaptable to any manner of work vehicle configuration 100. For example, in an alternative embodiment, a separate frame or chassis may be provided to which the engine 118, transmission 114, and differential 116 are coupled, a configuration common in smaller tractors. Still other configurations may use an articulated chassis to steer the work vehicle 100, or rely on tracks in lieu of the wheels 102, 104. Additionally, although not shown, the work vehicle 100 may also be configured to be operably coupled to any suitable type of work implement, such as a trailer, spray boom, manure tank, feed grinder, plow and/or the like.

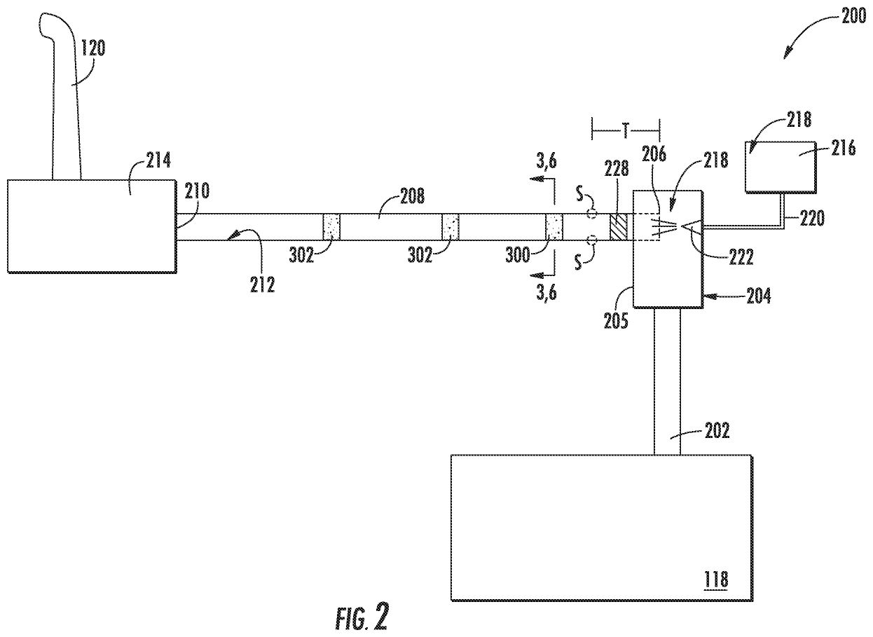

Referring now to FIG. 2, a schematic diagram of one embodiment of an exhaust treatment system 200 suitable for use with a work vehicle 100 is illustrated in accordance with aspects of the present subject matter. As represented in FIG. 2, the exhaust treatment system includes an exhaust conduit 202, a diesel oxidation catalyst (DOC) system 204, a mixing conduit 208, and a selective catalytic reduction (SCR) system 214. During operation of the work vehicle 10, exhaust expelled from the engine 118 is received by the exhaust conduit 202 and flows through the conduit 202. to the DOC system 204. As is generally understood, the DOC system 204 is configured to reduce the levels of carbon monoxide and hydrocarbons present in the engine exhaust. For example, as shown in FIG. 2, the DOC system 204 includes a canister or chamber 205 for receiving engine exhaust from the exhaust conduit 202, with the chamber 205 being in flow communication with an upstream end 206 of the mixing conduit 208. In addition, the DOC system 204 includes a reductant injector nozzle 222 provided in association with the chamber 205 at a location at or adjacent to the upstream end 206 of the mixing conduit 208 to allow an exhaust reductant 218, such as a diesel exhaust fluid (DEF) or any other suitable urea-based fluid, to be injected into the stream of exhaust gases flowing through the chamber 205. For instance, as shown in FIG. 2, the reductant injector nozzle 222 may be fluidly coupled to a source of exhaust reductant (e.g., storage tank 216) via a hose or other fluid coupling 220 to allow liquid exhaust reductant to be supplied to the nozzle 222. The engine exhaust and exhaust reductant flowing into the upstream end 206 of the mixing conduit 208 are then directed through the conduit 208 to the downstream end 210 thereof for receipt by the SCR. system 214, within which the mixture of exhaust/reductant is reacted with a catalyst to reduce the amount of nitrous oxide (NOx) emissions contained within the engine exhaust. The treated exhaust is then expelled from the exhaust treatment system via the exhaust pipe 120 into the atmosphere.

As the exhaust/reductant flows into and through the mixing conduit 218, a portion of the reductant evaporates and mixes with the engine exhaust. However, as indicated above, some portion of the injected exhaust reductant 218 typically does not initially evaporate/mix with the engine exhaust, but, instead impinges on an inner conduit wall 212 of the mixing conduit 208 and forms a flow of liquid reductant along the wall 212. The attachment of the liquid exhaust reductant to the conduit wall 212 generally occurs at a location downstream of the upstream end 206 of the mixing conduit 208, which, for purposes of description, will generally be referred to herein as the “reductant attachment location” and is labeled as “S” in the figures. It should be appreciated that the specific downstream location of the reductant attachment location S may generally vary depending on the configuration of the mixing conduit 208 and/or the reductant injector nozzle 222, the flow properties of the engine exhaust and/or the reductant within the DOC system 204 and/or the mixing conduit 208, and/or other relevant factors. However, in one embodiment, the reductant attachment location S may generally be defined at a downstream location separated from the upstream end 206 of the mixing conduit 208 by a distance T that is equal to greater than 1% of the total length of the mixing conduit 208 defined between its upstream and downstream ends 206, 210, such as a distance T greater than 2% of the total length of the mixing conduit 208 or greater than 5% of the total length of the mixing conduit 208 or greater than 10% of the total length of the mixing conduit 208.

To allow for separation of the liquid reductant flow from the inner conduit wall 212, at least one flow separation region 300 is provided within or in operative association with the mixing conduit 208 at a location downstream of the reductant attachment location S and upstream of the downstream end 210 of the mixing conduit 210. As will be described below, one or more flow separation features (e.g., one or more nozzles and/or flow separation elements) may form part of or may be included within the flow separation region 300 of the mixing conduit 208 that are configured to separate the liquid reductant flow from the inner conduit wall 212. As a result, upon encountering the flow separation region 300, at least a portion of the liquid reductant flow is separated from the inner conduit wall 212 and directed generally toward the centerline of the mixing conduit 208. In so doing, at least a portion of the liquid reductant flow is reintroduced to, and mixed with, the engine exhaust flow

Still referring to FIG. 2, it should be appreciated that, in some applications following reintroduction of the liquid reductant flow into the exhaust flow at the flow separation region 300, portions of the exhaust reductant 218 may still have a tendency to centrifuge and impinge on the inner conduit wall 212 at a location downstream of the flow separation region 300. In such embodiments, one or more secondary flow separation regions 302 may be provided downstream of the initial flow separation region 300 to allow for the liquid reductant flow to again be separated from the inner conduit wall 212 at such downstream locations. Each secondary flow separation region 302 may similarly include one or more flow separation features (e.g., one or more nozzles and/or flow separation elements) configured to separate the liquid reductant flow from the inner conduit wall 212.

It should also be appreciated that, in some embodiments, the exhaust treatment system 200 may further include a mixing component or mixer 228 installed within the mixing conduit 208 to impart rotation or turbulence into the engine exhaust flow. As shown in FIG. 2, in one embodiment, the mixer 228 may be installed within the mixing conduit 208 at a location between the upstream end 206 of the conduit 208 and the initial flow separation region 300, such as at a location between the upstream end 206 of the conduit 208 and the reductant attachment location S.

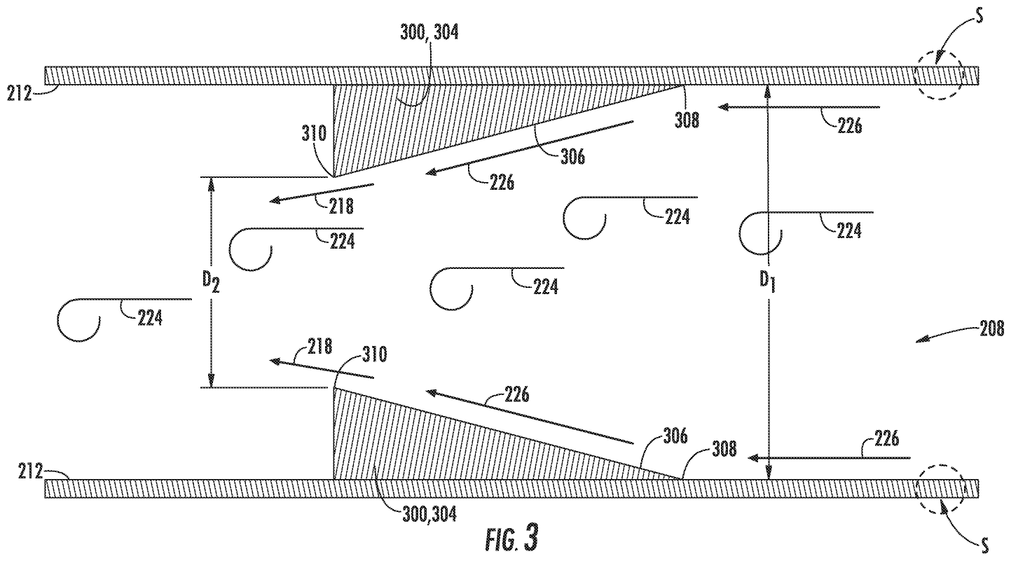

Referring now to FIG, 3, a cross-sectional view of a portion of the mixing conduit 208 of the exhaust treatment system 200 shown in FIG. 2 taken about line 3,6-3,6 is illustrated in accordance with aspects of the present subject matter, particularly illustrating one embodiment of the flow separation region 300 of the mixing conduit 208. As shown in FIG. 3, the flow separation region 300 of the mixing conduit 208 includes a flow separation nozzle 304 located downstream of the reductant attachment location S. In the illustrated embodiment, the flow separation nozzle 304 corresponds to a separate insert configured to be installed within the mixing conduit 208. However, in other embodiments, the flow separation nozzle 304 may be formed integrally with the mixing conduit 208 and/or may be included as part of a separate conduit section forming an axial section of the mixing conduit 208.

As shown in FIG. 3, the flow separation nozzle 304 includes a nozzle wall 306 extending between an upstream wall end 308 and a downstream wall end 310 of the nozzle 304. As shown in the illustrated embodiment, the nozzle wall 306 defines a radially converging nozzle profile between the upstream and downstream wall ends 308, 310 such that an upstream diameter D₁ of the nozzle defined at the upstream wall end 308 is greater than a downstream diameter D₂ of the nozzle at the downstream wall end 310. For example, in one embodiment, the upstream diameter D₁ may generally be equal to the inner diameter of the mixing conduit while the downstream diameter D₂ is equal to a diameter ranging from about 50% to about 95% of the inner diameter of the mixing conduit. In such an embodiment, the nozzle wall 306 may generally define a cross-sectional profile having a radially inclined plane where the upstream wall end 308 is in contact with the inner conduit wall 212 of the mixing conduit 208 and the downstream wall end 310 is positioned axially downstream of and radially inwardly relative to the upstream wall end 308. It should be appreciated that the converging profile of the nozzle wall 306 dictates that the diameter of the flow area within the mixing conduit 208 decreases along a length of the nozzle wall 306.

Given the radially inwardly converging configuration of the flow separation nozzle 304 shown in FIG. 3, the nozzle 304 may be configured to separate the liquid reductant flow (represented by lines 226 in FIG. 3) from the inner conduit wall 212 and reintroduce such flow 226 back into the engine exhaust flow (represented in FIG. 3 by lines 224) directed through the nozzle 304. Specifically, when the liquid reductant flow 226 flowing along the inner conduit wall 212 encounters the upstream wall end 308 of the nozzle 304, the liquid reductant flow 226 is directed along the radially inwardly converging nozzle wall 306 towards the downstream wall end 310 of the nozzle 304. Upon reaching the downstream wall end 310, the liquid reductant flow 226 separates from the nozzle wall 306 and is reintroduced to the engine exhaust flow 224, where the exhaust reductant 218 is again available for mixing with the engine exhaust flow 224. In doing so, the increased velocity of the engine exhaust gases flowing through the converging nozzle 304 may assist in forcing the liquid reductant flow 226 away from the inner conduit wall 212 as it flows across the nozzle wall 306 and separates therefrom at the downstream wall end 310 of the nozzle 304 It should be appreciated that, although the nozzle has been described above in terms of a converging nozzle with a right-triangular profile, the nozzle could also define a converging-diverging profile with any triangular profile or define any other suitable nozzle profile.

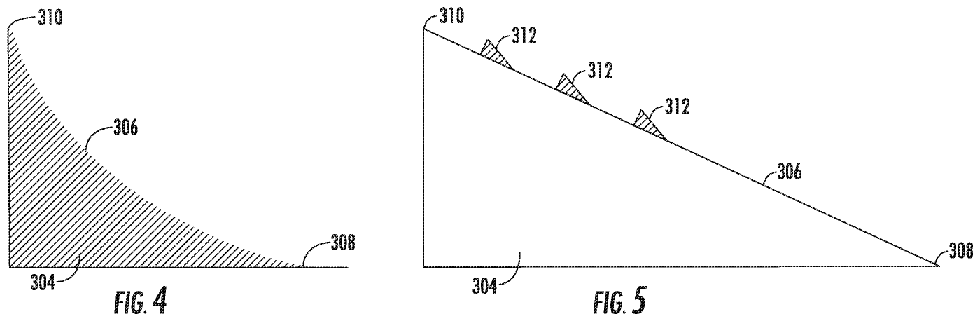

Referring now to FIG. 4, a cross-sectional view of another embodiment of a suitable nozzle configuration for the flow separation nozzle 304 described above with reference to FIG. 3 is illustrated in accordance with aspects of the present subject matter. As shown in FIG. 4, unlike the straight or planar converging cross-sectional profile described above, the nozzle wall 306 defines an arcuate or curved cross-sectional profile between the upstream wall end 308 and the downstream wall end 310 of the nozzle 304. For instance, in the illustrated embodiment, the nozzle wall 306 defines a concavely shaped cross-sectional profile between the upstream and downstream wall ends 308, 310 of the nozzle 304. However, in other embodiments, the nozzle wall 306 may define any other suitable cross-sectional profile between the ends 308, 310 of the nozzle 304, such as a wavy profile, a stepped profile, and/or the like.

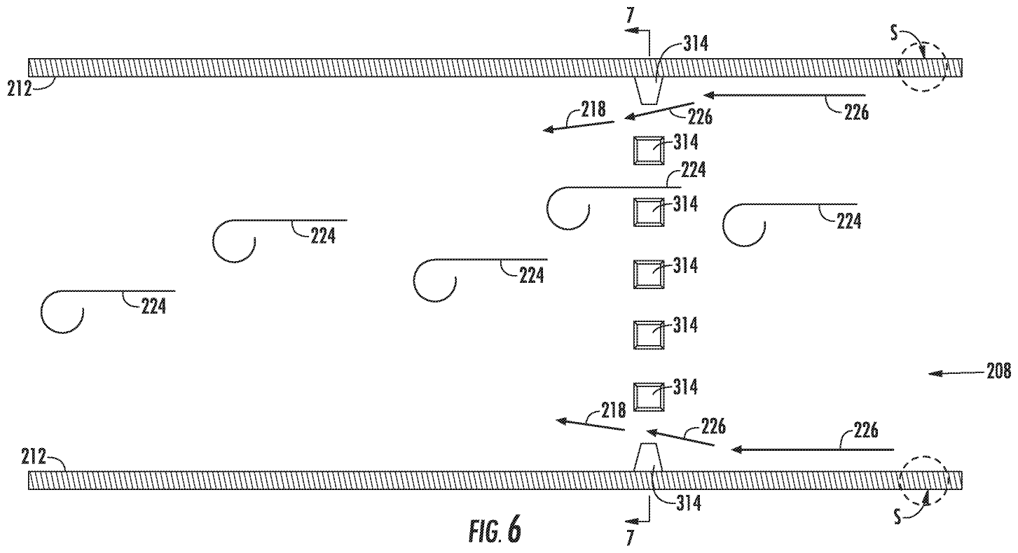

Referring now to FIG. 5, another cross-sectional view of a further embodiment of a suitable nozzle configuration for the flow separation nozzle 304 described above with reference to FIG. 3 is illustrated in accordance with aspects of the present subject matter. As shown in FIG, 5, the flow separation nozzle 304 is generally configured the same as or similar to the nozzle 304 described above with reference to FIG. 3, such as by including a nozzle wall defining a converging, planar cross-sectional profile between the downstream and upstream walls ends 308, 310 of the nozzle 304. However, unlike the embodiment described above, the nozzle wall 306 includes a plurality of flow separation elements 312 coupled thereto or formed thereon. As will be described below, such flow separation elements 312 may correspond to any suitable elements that are configured to facilitate separation of the liquid reductant flow from an adjacent surface or wall. In several embodiments, each flow separation element may correspond to a separate turbulator-like element configured to disrupt or otherwise alter the flow of liquid reductant along the nozzle wall 306. For instance, as shown in FIG. 5, each flow separation element 312 corresponds to a ridge, rib, or other protrusion extending radially inwardly from the nozzle wall 306. However, in other embodiments, the flow separation elements 312 may correspond to dimples, recesses, or any other radially inwardly extending indentations defined in or relative to the nozzle wall 306 or a combination of radially outwardly projecting protrusions and radially inwardly extending indentations.

It should be appreciated that, although the above-described nozzle configurations are generally described with reference to the initial flow separation region 300 of FIG. 2, the same or similar nozzle configurations may also be provided in association any other flow separation region associated with the mixing conduit, such as any of the secondary or downstream flow separation regions 302. For instance, in one embodiment, each secondary or downstream flow separation region 302 may include a flow separation nozzle in association therewith.

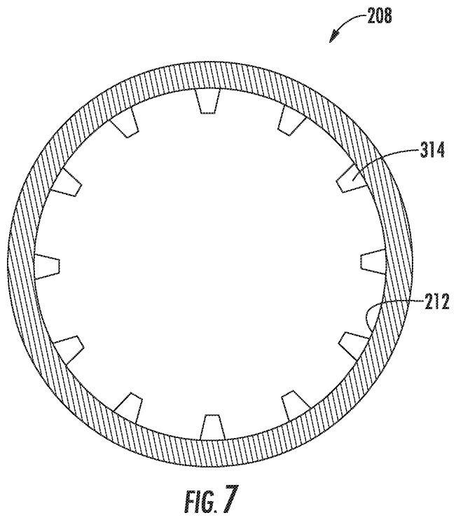

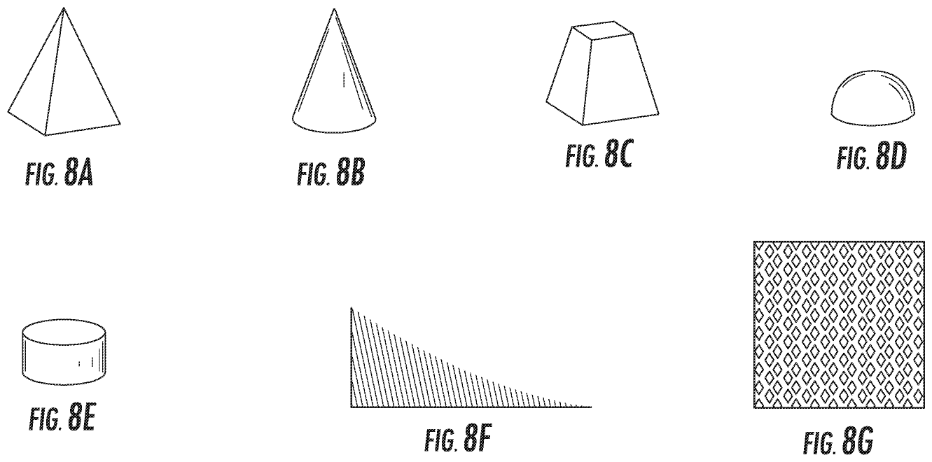

Referring now to FIGS. 6 and 7, further cross-sectional views of a portion of the mixing conduit 208 of the exhaust treatment system 200 shown in FIG. 2 are illustrated in accordance with aspects of the present subject matter, particularly illustrating another embodiment of the flow separation region 300 of the mixing conduit 208. Specifically, FIG. 6 illustrates a cross-sectional view of the mixing conduit 208 shown in FIG. 2 taken about line 3,6-3,6. Additionally, FIG. 7 illustrates a cross-sectional view of the mixing conduit shown in FIG. 6 taken about line 7-7.

As shown in FIGS. 6 and 7, the flow separation region 300 of the mixing conduit 208 includes a plurality of flow separation elements 314 provided in association with the inner conduit wall 212 at a location downstream of the reductant attachment location S. Specifically, as shown in the illustrated embodiment, each flow separation element 314 corresponds to a rib, or other protrusion extending radially inwardly from the inner conduit wall 212 into the flow area defined by the mixing conduit 208. As a result, the flow separation elements 314 may be configured to disrupt or otherwise alter the flow of liquid reductant along the inner conduit wall 212. For instance, as the liquid reductant flow 226 advances along the inner conduit wall 212 from the reductant attachment location S, one or more portions of the liquid reductant flow 226 encounter or contact the flow separation elements 314, thereby facilitating separation of such portion(s) of the liquid reductant flow from the inner conduit wall 212 to allow the reductant 218 to be intermixed with the engine exhaust flow 224.

It should be appreciated that, when the flow separation elements 314 are configured as radially inwardly extending protrusions, such elements 314 may generally have any suitable shape(s) that facilitates separation of at least a portion of the liquid reductant flow 226 from the inner conduit wall 212. when such portion of the flow 226 contacts or encounters a given flow separation element 312. For example, FIGS. 8A-8G illustrate various examples of suitable shapes or profiles that may be utilized for the flow separation elements 314. Specifically, one or more of the flow separation elements 314 may be configured as a pyramid (FIG. 8A), a cone (FIG. 813), a frustum (FIG. 8C), a hemisphere (FIG. 8D), a cylinder (FIG. 8E), and/or any other suitable shape. In another embodiment, one or more of the flow separation elements 314 may have a hybrid shape, e.g., a generally triangular profile having a concave face, as depicted in FIG. 8F. In still other embodiments, the flow separation elements 314 may include shapes and forms such as ribs, ridges, turbulator tape, moniliforms, wires, hemi-lachrymiforms, hemi-reniforms, arches, cruciforms, aciculiforms or prisms.

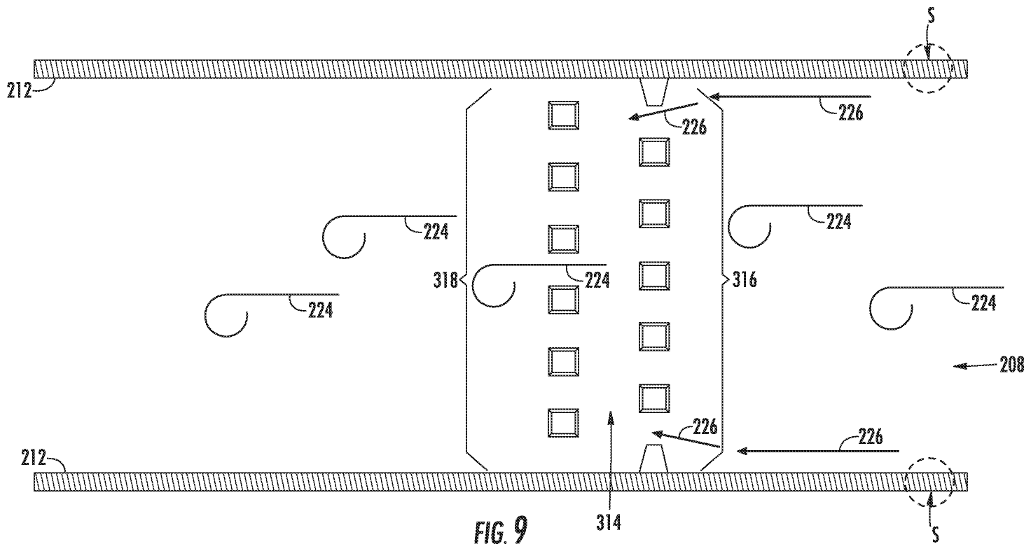

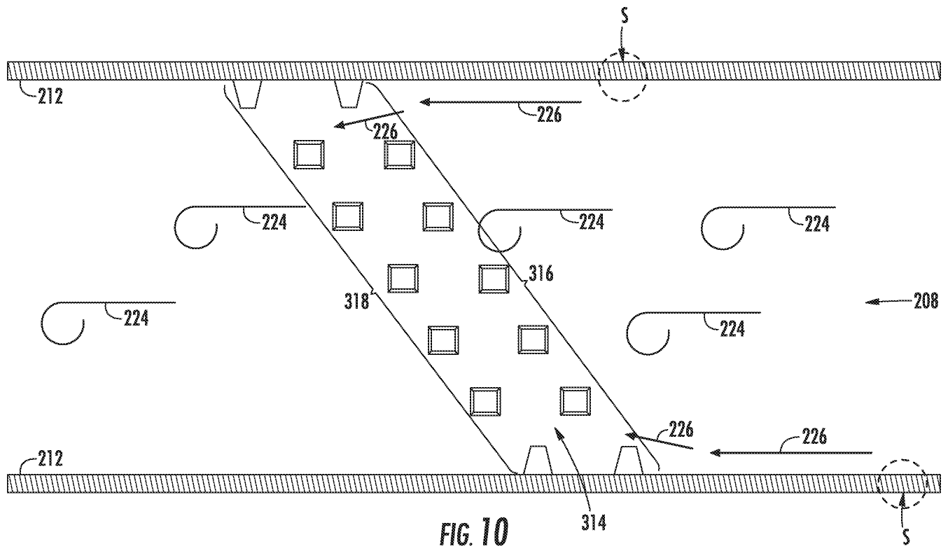

Referring back to FIGS. 6 and 7, as shown in the illustrated embodiment, the flow separation elements 314 are generally disposed in an annular array around the inner conduit wall 212 of the mixing conduit 208. Specifically, as shown in FIGS. 6 and 7, the flow separation elements 314 are all positioned at the same axial location along the length of the mixing conduit 208, with each flow separation element 314 being spaced apart circumferentially from adjacent or neighboring flow separation elements 314 around the inner perimeter of the conduit 208. However, in other embodiments, the flow separation elements 314 may be provided in any other suitable arrangement within the mixing conduit 208, such as by being axially staggered or offset and/or by being circumferentially aligned. For instance, FIG. 9 illustrates an arrangement in which the flow separation elements 314 are provided in separate annular arrays. Specifically, as shown in FIG. 9, a first annular array 316 of flow separation elements is provided at a first axial location downstream of the reductant attachment location S and a second annular array 318 of flow separation elements is provided downstream of the first annular array 316 at a second axial location. As shown in FIG. 9, the annular arrays 316, 318 of flow separation elements are axially staggered relative to one another along a length of the mixing conduit. Additionally, as shown in FIG. 9, the flow separation elements 314 of the first array 316 are circumferentially offset from the flow separation elements 314 of the second array 318. However, in other embodiments, corresponding flow separation elements 314 of the first and second arrays 316, 318 may be configured to be circumferentially aligned with each other. Moreover, yet another example of a suitable arrangement for the flow separation elements 314 is illustrated in FIG. 10. Similar to the embodiment described above, the flow separation elements 314 are provided in two separate arrays (e.g., a first array 316 and a second array 318). However, unlike the embodiment described above with reference to FIG. 9, the first and second arrays 316, 318 include circumferentially aligned flow separation elements, with each array including axially staggered flow separation elements 314.

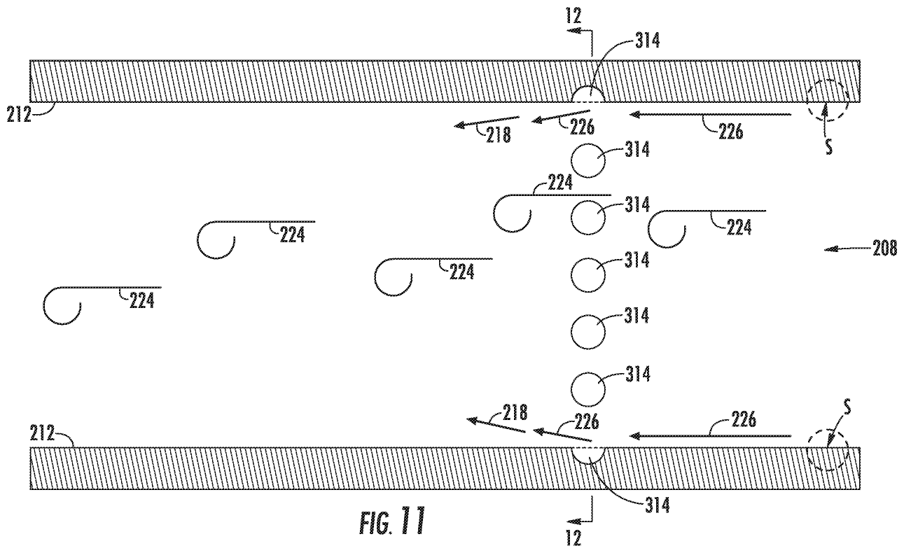

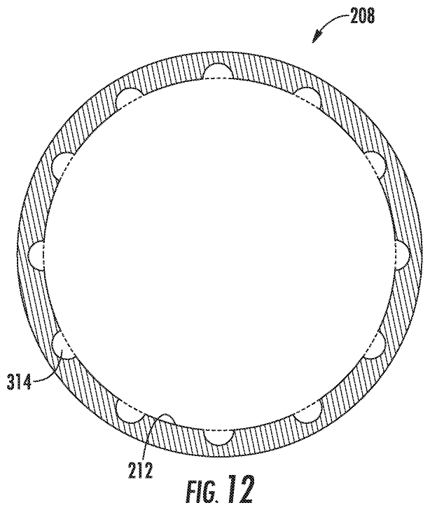

Referring now to FIGS. 11 and 12, similar cross-sectional views of the portion of the mixing conduit 208 of the exhaust treatment system 200 shown in FIGS. 6 and 7 are illustrated in accordance with aspects of the present subject matter. Specifically, FIG. 11 illustrates a similar cross-sectional view of the mixing conduit 208 as that shown in FIG. 6, particularly illustrating yet another embodiment of the flow separation region 300 of the mixing conduit 208. Additionally, FIG. 12 illustrates a cross-sectional view of the mixing conduit shown in FIG. 11 taken about line 12-12.

As shown in FIGS. 11 and 12, similar to that shown in FIGS. 6 and 7, the flow separation region 300 of the mixing conduit 208 includes a plurality of flow separation elements 314 provided in association with the inner conduit wall 212 at a location downstream of the reductant attachment location S. However, unlike the embodiments described above in which the flow separation elements correspond to radially inwardly projecting protrusions, the flow separation elements 314 correspond to radially inwardly extending indentations defined relative to the inner conduit wall 212 of the mixing conduit. As a result, the flow separation elements 314 may be configured to disrupt or otherwise alter the flow of liquid reductant along the inner conduit wall 212. For instance, as the liquid reductant flow 226 advances along the inner conduit wall 212 from the reductant attachment location S, one or more portions of the liquid reductant flow 226 encounters the flow separation elements 314, thereby facilitating separation of such portion(s) of the liquid reductant flow from the inner conduit wall 212 to allow the reductant 218 to be intermixed with the engine exhaust flow 224.

It should be appreciated that, when the flow separation elements 314 are configured as indentations, each element 314 may generally have any suitable shape(s) that facilitates separation of at least a portion of the liquid reductant flow 226 from the inner conduit wall 212. when such portion of the flow 226 encounters a given flow separation element 314. For example, as depicted in FIGS. 11 and 12, the indentations may he dimples, or as depicted in FIG. 8G, the indentations may be an area of knurling. Additionally, the indentations may take the negative form of any of the various protrusion shapes described above with reference to FIGS. 8A-8F.

It should be appreciated that, although the above-described configurations for the flow separation elements 314 are generally described with reference to the initial flow separation region 300 of FIG. 2, the same or similar flow separation element configurations may also be provided in association with any other flow separation region associated with the mixing conduit, such as any of the secondary or downstream flow separation regions 302. For instance, in one embodiment, each secondary or downstream flow separation region 302 may include a plurality of flow separation elements 314 positioned therein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed:

1. An exhaust treatment system for a work vehicle, the system comprising:
an exhaust conduit configured to receive an engine exhaust flow;
a reductant injector configured to inject an exhaust reductant into the engine exhaust flow;
a mixing conduit extending lengthwise between an upstream end and a downstream end, the mixing conduit including an inner conduit wall defining a flow area through which the engine exhaust flow and the exhaust reductant are directed between the upstream and downstream ends of the mixing conduit to allow the exhaust reductant to be at least partially mixed into the engine exhaust flow, a portion of the exhaust reductant flowing along the inner conduit wall of the mixing conduit as a liquid reductant flow; and
a flow separation nozzle provided in association with the mixing conduit at a location between its upstream and downstream ends, the flow separation nozzle including a nozzle wall extending between an upstream wall end and a downstream wall end, the nozzle wall defining a radially inwardly converging profile between its upstream and downstream wall ends,
wherein the flow separation nozzle is positioned within the mixing conduit such that the liquid reductant flow flowing along the inner conduit wall is directed across the nozzle wall and separates from the flow separation nozzle for mixing with the engine exhaust flow flowing through the flow separation nozzle.

2. The system of claim 1, wherein the liquid reductant flow is initiated along the inner conduit wall at a location at or downstream of a reductant attachment location disposed between the upstream and downstream ends of the mixing conduit, the flow separation nozzle being positioned within the mixing conduit downstream of the reductant attachment location.

3. The system of claim 1, further comprising a mixer positioned within the mixing conduit between the upstream end of the mixing conduit and the flow separation nozzle.

4. The system of claim 1, wherein the nozzle wall defines a planar cross-sectional profile between the downstream and upstream wall ends of the flow separation nozzle.

5. The system of claim 1, wherein the nozzle wall defines a curved cross-sectional profile between the downstream and upstream wall ends of the flow separation nozzle.

6. The system of claim 1, further comprising a plurality of flow separation elements provided on the nozzle wall.

7. The system of claim 6, wherein the plurality of flow separation elements comprise a plurality of radially inwardly projecting protrusions.

8. The system of claim 6, wherein the plurality of flow separation elements comprise a plurality of radially outwardly extending indentations formed in the nozzle wall.

9. The system of claim 1, wherein the flow separation nozzle is a first flow separation nozzle, the system further comprising at least one secondary flow separation nozzle located downstream of the first flow separation nozzle.

10. The system of claim 1, further comprising a selective catalytic reduction system configured to receive the mixture of exhaust reductant and engine exhaust flow directed from the downstream end of the mixing conduit.

11. A work vehicle, comprising:
an engine expelling an engine exhaust flow;
an exhaust conduit configured to receive an engine exhaust flow;
a reductant injector configured to inject an exhaust reductant into the engine exhaust flow;
a mixing conduit extending lengthwise between an upstream end and a downstream end, the mixing conduit including an inner conduit wall defining a flow area through which the engine exhaust flow and the exhaust reductant are directed between the upstream and downstream ends of the mixing conduit to allow the exhaust reductant to be at least partially mixed into the engine exhaust flow, a portion of the exhaust reductant flowing along the inner conduit wall of the mixing conduit as a liquid reductant flow; and
a flow separation nozzle provided in association with the mixing conduit at a location between its upstream and downstream ends, the flow separation nozzle including a nozzle wall extending between an upstream wall end and a downstream wall end, the nozzle wall defining a radially inwardly converging profile between its upstream and downstream wall ends,
wherein the flow separation nozzle is positioned within the mixing conduit such that the liquid reductant flow flowing along the inner conduit wall is directed across the nozzle wall and separates from the flow separation nozzle for mixing with the engine exhaust flow flowing through the flow separation nozzle.

12. The work vehicle of claim 11, wherein the liquid reductant flow is initiated along the inner conduit wall at a location at or downstream of a reductant attachment location disposed between the upstream and downstream ends of the mixing conduit, the flow separation nozzle being positioned within the mixing conduit downstream of the reductant attachment location.

13. The work vehicle of claim 11, further comprising a mixer positioned within the mixing conduit between the upstream end of the mixing conduit and the flow separation nozzle.

14. The work vehicle of claim 11, wherein the nozzle wall defines a planar cross-sectional profile between the downstream and upstream wall ends of the flow separation nozzle.

15. The work vehicle of claim 11, wherein the nozzle wall defines a curved cross-sectional profile between the downstream and upstream wall ends of the flow separation nozzle.

16. The work vehicle of claim 11, further comprising a plurality of flow separation elements provided on the nozzle wall.

17. The work vehicle of claim 16, wherein the plurality of flow separation elements comprise a plurality of radially inwardly projecting protrusions.

18. The work vehicle of claim 16, wherein the plurality of flow separation elements comprise a plurality of radially outwardly extending indentations formed in the nozzle wall.

19. The work vehicle of claim 11, wherein the flow separation nozzle is a first flow separation nozzle, the system further comprising at least one secondary flow separation nozzle located downstream of the first flow separation nozzle.

20. The work vehicle of claim 11, further comprising a selective catalytic reduction (SCR) system configured to receive the mixture of exhaust reductant and engine exhaust flow directed from the downstream end of the mixing conduit.
